(19) United States
(12) Patent Application Publication
(10) Pub. No.: US 2016/0279752 A1
(43) Pub. Date: Sep. 29, 2016

(54) Device for Protecting an Operator from being Injured by a Machine Tool, and Method for this Purpose

(71) Applicant: ROBERT BOSCH GMBH, Stuttgart (DE)

(72) Inventors: Philipp Zipf, Stuttgart-Zuffenhausen (DE); Joachim Schadow, Stuttgart (DE)

(21) Appl. No.: 15/029,708

(22) PCT Filed: Oct. 7, 2014
(86) PCT No.: PCT/EP2014/071435

§ 371 Date: Apr. 15, 2016

(30) Foreign Application Priority Data
Oct. 17, 2013 (DE) 102013221128.7

(51) Int. Cl. B23Q 11/00; G08B 21/02; F16P 3/14

(52) U.S. Cl. CPC B23Q 11/0082; F16P 3/147; G08B 21/02

(57) ABSTRACT

A device for protecting an operator from being injured by a machine tool includes at least one sensor unit, which is arranged on a garment unit, and is configured to detect at least one personalized characteristic variable. The device further includes at least one analyzing unit configured to analyze the at least one detected personalized characteristic variable.

### PRIOR ART

DE 10 2007 035 822 A1 has already disclosed a device and a method for protecting an operator from being injured by a machine tool, comprising at least one sensor unit arranged in a clothing unit for detecting at least one characteristic variable and comprising at least one evaluation unit for evaluating the at least one detected characteristic variable. The sensor unit of the device has conductor loops, which consist of metallic conductors and which are connected to the evaluation unit. The conductor loops form part of a woven or knitted fabric of the clothing unit and are arranged at those points of the clothing unit at which contact with the machine tool is possible or probable. The machine tool embodied as a chainsaw comprises a plurality of transmitters at regular intervals along a saw bar, which transmitters generate alternating radiofrequency fields on both sides of the saw bar. The evaluation unit evaluates the voltage induced in the conductor loops by the alternating radiofrequency fields of the transmitters or evaluates the detected characteristic variables and compares these with the predetermined characteristic variables. If the detected characteristic variables exceed the predetermined characteristic variable in one or more conductor loops, the desired minimum safety distance between the saw bar and the clothing unit is undershot at at least one point and there is the risk of contact between the saw bar of the machine tool and the clothing unit. In order to reliably prevent injury to the operator, a shutdown signal is transferred to the motor controller of the machine tool and the machine tool is shut down.

### DISCLOSURE OF THE INVENTION

The invention proceeds from a device for protecting an operator from being injured by a machine tool, in particular by a handheld machine tool, comprising at least one sensor unit arranged on a clothing unit for detecting at least one characteristic variable and comprising at least one evaluation unit for evaluating the at least one detected characteristic variable.

It is proposed that the sensor unit is provided to detect person-related characteristic variables. In particular, a “machine tool” should be understood to mean a workpiece-machining portable machine, but advantageously mean a chainsaw, a circular saw, a drill, a drill hammer, a percussion hammer, a plane, a screwdriver, a milling machine, a grinder, an angle grinder, a garden tool and/or a multifunctional tool. In this context, a “sensor unit” should be understood to mean, in particular, a unit provided to detect at least one characteristic variable and/or one physical property, wherein the detection can take place in an active manner, such as, in particular, by the generation and emission of an electrical measurement signal, and/or in a passive manner, such as, in particular, by detecting changes in properties of a sensor element and/or by detecting a current flowing over a resistor and/or a voltage. By way of example, the person-related characteristic variable is embodied as information about a posture or about a state or a position of an operator of the machine tool. In particular, current characteristic variables of the sensor unit can advantageously be detected in an active manner. What this can achieve, in particular, is that the machine tool can be influenced in a particularly safe and simple manner before the operator identifies a risk or is exposed thereto. By way of the design of the device according to the invention, it is possible to influence the machine tool particularly quickly, without an operator having specific knowledge of the sensor unit. Preferably, the sensor unit is worked into a woven or knitted fabric of the clothing unit. The sensor unit comprises at least one sensor element. “Provided” should be understood to mean, in particular, specifically programmed, specifically designed and/or specifically equipped. In particular, a “person-related characteristic variable” should be understood to mean at least one item of information about a state or about sensitivities of an operator, which comprises at least one movement characteristic variable and/or one vital function characteristic variable or a life function characteristic variable and/or a posture characteristic variable. Advantageously, the person-related characteristic variable has unique information in respect of the location of the operator, in particular a geographic coordinate characteristic variable of the location. Furthermore, the characteristic variable can comprise further information appearing expedient to a person skilled in the art. Different methods can be used in the sensor unit in order to detect the person-related characteristic variable. In this context, a “detection” should be understood to mean, in particular, a registration of the detected person-related characteristic variables from the at least one sensor unit. Furthermore, an “evaluation” in this context should be understood to mean, in particular, a comparison of the detected person-related characteristic variables with at least one predetermined characteristic variable stored in the evaluation unit and a generation of a signal dependent on a result of the comparison. In particular, the evaluation unit is provided to compare the detected person-related characteristic variables from the sensor unit, which are generated by the operator of the machine tool, with the predetermined characteristic variables of the sensor unit stored or saved in the evaluation unit and to output a signal if the predetermined characteristic variable of the sensor unit is exceeded. As a result of the design of the device according to the invention, permanent monitoring of the operator before, during and after a machining process with a machine tool is possible, as a result of which active protection against the operator being injured can be provided. Advantageously, this allows a dangerous situation to be identified in good time or be avoided and a state of the operator to be monitored at all times. In particular, the clothing unit is safety-relevant personal protective equipment of the operator against imminent risks, which, for example, is embodied as a jacket and/or as trousers and/or as an overall and/or as a glove and/or as a protective helmet and/or as a shoe and/or as a belt and/or as an armband. All or different body parts of the operator can be protected from contact with a machining tool and from imminent danger or injury resulting from the contact.

Moreover, the sensor unit comprising at least one acceleration sensor element for detecting jerky movements of the operator is proposed. In particular, the acceleration sensor element is provided to detect an acceleration or an increase in speed or decrease in speed of the operator as a person-related characteristic variable, in particular as a movement characteristic variable, in a manner dependent on the movement of the operator. The detected person-related characteristic variables from the acceleration sensor element can be output to the evaluation unit at all times, said evaluation unit being able to compare the detected person-related characteristic variables from the acceleration sensor element with the at least one predetermined characteristic variable of the acceleration sensor element, stored in the evaluation unit, and being able to output a signal in the case where the predetermined characteristic variable of the acceleration sensor element is exceeded. In particular, a movement deviating from a uniform movement of the operator can be registered by virtue of the inertial force acting on a body part of the operator being determined. Preferably, the acceleration sensor element is arranged in the clothing unit in the region of the hands and/or the feet and/or the head of the operator, as a result of which the jerky movements can be detected unambiguously. In an alternative embodiment, the acceleration sensor element can be arranged at a wrist and/or at an arm of the operator. In a further alternative embodiment, the acceleration sensor element can be integrated into a watch or it can be embodied as a watch or as an armband. Advantageously, one or more acceleration sensor elements can be connected to the evaluation unit in a wired and/or wireless manner. Preferably, the acceleration sensor element in the clothing unit has a wired embodiment. In particular, the manually guided machine tool can be deactivated automatically in the case of jerky movements of the operator, for example if the operator must absorb a kickback of an angle grinder during a machining process or if a saw chain of the chainsaw suddenly rips or if there is a kickback of the chainsaw as a result of the saw chain being caught. On account of the small size thereof, the acceleration sensor elements can be particularly advantageously integrated into a clothing unit. In particular, the acceleration sensor element has a particularly low weight and a high reliability. In particular, increased ease of use can be obtained. Furthermore, the manufacturing costs of the acceleration sensor elements are low, as a result of which it is possible to equip the clothing unit with acceleration sensor elements in a particularly cost-effective manner.

Furthermore, the sensor unit comprising at least one position sensor element or a GPS (GPS=global positioning system) sensor element for detecting a horizontal and/or a vertical position and/or a geographical location of the operator is proposed. The position sensor element is provided to detect an inclination angle, an angle measurement or a location of the operator as a person-related characteristic variable, in particular as a posture characteristic variable. The posture characteristic variable provides information about the posture or about the position of the operator in a manner dependent on the ground on which the operator stands during a machining process. The detected person-related characteristic variables of the position sensor element can be output to the evaluation unit at all times, said evaluation unit being able to compare the detected person-related characteristic variables from the position sensor element with the at least one predetermined characteristic variable of the position sensor element, stored in the evaluation unit, and being able to output a signal in the case where the predetermined characteristic variable of the position sensor element is exceeded. The GPS sensor element is provided to detect a location of the operator as a person-related characteristic variable, in particular as a geographic coordinate characteristic variable. The detected person-related characteristic variables from the GPS sensor element can be output to the evaluation unit at all times and can be read out in the case of an emergency. Within the scope of the invention, such a sensor element can be used under safety and comfort aspects. Advantageously, one or more position sensor elements or GPS sensor elements can be connected to the evaluation unit in a wired and/or wireless manner. Preferably, the position sensor element or the GPS sensor element in the clothing unit has a wired embodiment. The machine tool, in particular a manually guided machine tool, can be deactivated automatically in the case of irregular handling circumstances, for example if the operator trips up during a machining process and falls over with the machine tool. In particular, the position sensor element or the GPS sensor element is integrated into the clothing unit and arranged in a manner protected from external influences. In an alternative embodiment, the position sensor element or the GPS sensor element can be arranged at a wrist and/or at an arm of the operator. In a further alternative embodiment, the position sensor element or the GPS sensor element can be integrated into a watch or it can be embodied as a watch or as an armband.

Furthermore, the sensor unit comprising at least one vital sensor element for detecting a vital function of the operator is proposed. Preferably, a “vital function” should be understood to mean, in particular, a heart rate and/or a circulation and/or an arterial pulse and/or an arterial blood pressure and/or a respiration and/or a body temperature of the operator. In particular, the vital sensor element is provided to detect the vital functions of the operator as a person-related characteristic variable, in particular as a vital function characteristic variable. The detected person-related characteristic variables from the vital sensor element can be output to the evaluation unit at all times, said evaluation unit comparing the detected person-related characteristic variables from the vital sensor element with the at least one predetermined characteristic variable of the vital sensor element, stored in the evaluation unit, and being able to output a signal in the case where the predetermined characteristic variable of the vital sensor element is exceeded. In particular, the vital sensor element enables permanent monitoring with constant checking of the vital functions of the operator. Advantageously, one or more vital sensor elements can be connected to the evaluation unit in a wired and/or wireless manner.

Preferably, the vital sensor element in the clothing unit has a wired embodiment. In particular, each clothing unit has at least one vital sensor element which is automatically activatable in the put-on state. Alternatively, at least one clothing unit has a vital sensor element, with the operator having to put on said vital sensor element in order to activate the machine tool. In particular, the machine tool can only be activated if the operator puts on the clothing unit. In particular, the specific machine tool can only be activated if the operator puts on the clothing unit with a vital sensor element, provided for the machine tool. In particular, the machine tool is deactivated if the operator takes off the clothing unit. In particular, the vital sensor element can be a constituent of a belt. In an alternative embodiment, the vital sensor element can be arranged at a wrist and/or at an arm of the operator. In a further alternative embodiment, the vital sensor element can be integrated into a watch or it can be embodied as a watch or as an armband. In particular, the vital sensor element can protect the operator from stress by virtue of the machine tool being deactivated or it not being possible to put the machine tool into operation or activate the machine tool in the case of a predetermined person-related characteristic variable. In particular, the vital sensor element can protect the operator from stress by virtue of the machine tool being deactivated after predetermined machining duration and provision being made for a pause or a termination of work. Advantageously, the vital sensor element allows dangerous situations to be identified in good time and to be avoided. In particular, the vital sensor element can identify, record and transfer vital functions of an injured and/or unconscious operator. Advantageously, the detected vital functions can be used in situ in a targeted manner for immediate measures within the scope of first aid in the case of an emergency. In particular, the work colleagues in situ can be instructed by a medical practitioner over the telephone about life-saving immediate measures for ensuring the vital functions before the medical practitioner arrives at the injured person. Prior to the immediate measures, an emergency call and quick summoning of the emergency services including the paramedic can be carried out automatically. In particular, the vital sensor element allows an initiation of life-saving immediate measures for saving the operator in the case of a disorder or even failure of the vital function of the operator. The outlay of manufacturing the clothing unit with person-related sensor units only arises once and enables a closed safety system between human and machine.

Preferably, the sensor unit comprises the acceleration sensor element, the position sensor element, the GPS sensor element and the vital sensor element, with, however, other sensor elements appearing expedient to a person skilled in the art also being conceivable.

Furthermore, the device having a reception unit for receiving the at least one detected person-related characteristic variable from the evaluation unit is proposed. In particular, the person-related characteristic variables are transferred from the evaluation unit of the device to the reception unit in a wireless and/or wired manner. Preferably, the reception unit in the clothing unit has a wired embodiment and it is arranged in the region of the chest pocket or in the region of a trouser belt. In an alternative embodiment, the reception unit can be arranged at a wrist and/or at an arm of the operator. In a further alternative embodiment, the reception unit can be integrated into a watch or it can be embodied as a watch or as an armband. Advantageously, one evaluation unit or a plurality of evaluation units can be connected to the reception unit. In particular, the reception unit is activatable automatically when the first person-related characteristic variable is received by the evaluation unit and, prior to deactivation, it can be put initially into standby mode after a predetermined time in which person-related characteristic variables are not received has elapsed. In particular, the reception unit has an optical and/or acoustic energy state indicator. It is advantageously possible to enable the recording of person-related data by means of the design according to the invention.

Furthermore, the reception unit being arranged within the clothing unit or outside of the clothing unit is proposed. In particular, the wired or wireless reception unit is particularly advantageously integrated into the clothing unit as an internal reception unit, as a result of which particularly comfortable work is possible. In an alternative design, the reception unit can be embodied as an independent instrument or it can be integrated into an electronic unit such as e.g. a cellular telephone or a smartphone or a tablet PC. In an alternative embodiment, the reception unit can be arranged outside of the clothing unit as an external reception unit. In particular, an “external reception unit” should be understood to mean a unit with information input, information processing and information output. Advantageously, the external reception unit has at least one processor, memory, input and output means, an operating program, closed-loop control routines, open-loop control routines and/or calculation routines. Preferably, the components of the external reception unit are arranged on a common circuit board and/or they are advantageously arranged in a common housing. The external reception unit is preferably embodied as a computer appearing expedient to a person skilled in the art, but advantageously as a notebook, as a tablet PC, as a workstation, as a mobile telephone and/or, particularly advantageously, as a smartphone. The external reception unit can have a wired or wireless connection with the evaluation unit. Preferably, the external reception unit is connected to the evaluation unit in a wireless manner. In particular, the external reception unit connected in a wireless manner can enable particularly comfortable work. An external reception unit can be stored in a particularly protected manner and it can be protected from damage in a workshop or at a building site as a result of external influences which may arise in the clothing unit. The wireless connection of the external reception unit with the evaluation unit can be particularly advantageous since the clothing unit need not be connected to the external reception unit by way of a cable, which can be particularly impairing during the work with the machine tool. However, in principle, it is also possible to connect the external reception unit to the evaluation unit or to the internal reception unit by way of a cable.

Furthermore, the reception unit having a communication unit for transferring the at least one detected person-related characteristic variable to the machine tool and the machine tool being deactivatable in a manner dependent on the at least one predetermined person-related characteristic variable is proposed. In particular, the reception unit forms a bidirectional transmission/reception unit together with the communication unit, by means of which transmission/reception unit at least one person-related characteristic variable can be detected by the evaluation unit or data or at least one predetermined person-related characteristic variable can be transferred to the machine tool or to an external reception unit. In this context, a “communication unit” should be understood to mean, in particular, a unit provided to transfer or interchange electronic data signals and/or control signals and/or person-related characteristic variables. Preferably, this should be understood to mean, in particular, a unit which is at least provided to transfer electronic data signals and/or control signals and/or person-related characteristic variables in an active and/or passive manner, in particular to an external reception unit. Here, the electronic data signals and/or control signals and/or the person-related characteristic variables can be transferred both in analog and digital form. Furthermore, a transfer can be carried out in both a wireless and wired manner. Various wireless transfer techniques appearing expedient to a person skilled in the art are conceivable, such as e.g. using Bluetooth, WLAN, UMTS, NFC or using an optical interface. Moreover, various wired transfer techniques appearing expedient to a person skilled in the art are conceivable. Here, in this context, “active and/or passive” should be understood to mean, in particular, that data signals and/or control signals and/or person-related characteristic variables can be transferred in a completely active, completely passive, partly active or varyingly active, passive and partly active manner. Here, “passive” should be understood to mean, in particular, that the data signals and/or control signals and/or person-related characteristic variables from a transfer are read out by the reception unit. Furthermore, “partly active” should in this case be understood to mean, in particular, that data signals and/or control signals and/or person-related characteristic variables are only partly transferred actively. In particular, the evaluation unit can communicate with the reception unit arranged in the clothing unit and/or with an external reception unit and/or with a plurality of external reception units simultaneously, as a result of which the machine tool is deactivatable and, additionally, at least one emergency call can be placed in an emergency. In particular, the machine tool has a reception unit with a communication unit, by means of which there can be communication with, or deactivation of, the machine tool. Alternatively, machine tools without a reception unit having a communication unit can be retrofitted with a reception unit having a communication unit, which can be switched between the machine tool and the source of power, as a result of which all machine tools can be used and deactivated. This can ensure increased safety of the operator. In particular, costly single-man monitoring can be dispensed with since the operator can be monitored at all times from a central monitoring apparatus. As a result of the device according to the invention, costly staff costs can be reduced while at the same time improving the protection of the operator.

Furthermore, the reception unit being provided for monitoring a person and/or for transmitting and/or receiving an emergency signal is proposed. As a result of this, an emergency call can be placed automatically or emergency measures can be introduced within a very short period of time in order to save the operator, even if the operator is unconscious or severely injured. In particular, it is generally possible to dispense with a second person as a supervisor for the operator, in particular during a machining process with a machine tool.

Furthermore, the reception unit being provided to document and/or analyze the at least one received characteristic variable from the sensor unit is proposed. Preferably, external reception units can be used to store person-related characteristic variables or data. The person-related characteristic variables or data detected during the machining process can be, for example, processed and/or analyzed afterwards. In particular, it is possible to read out and evaluate the vital functions of the operator and/or the operation duration or the run-time of the machine tool which is used as loan or hire equipment. Preferably, the vital functions of the operator can be monitored and documented in real time on an external reception unit.

Furthermore, the invention moreover relates to a corresponding method for protecting an operator from being injured by a machine tool by means of a device according to the invention which comprises at least one sensor unit arranged on a clothing unit for detecting at least one characteristic variable and which comprises at least one evaluation unit for evaluating the at least one detected characteristic variable. In the method according to the invention, the sensor unit detects at least one person-related characteristic variable and transfers this by way of the evaluation unit to the reception unit provided to deactivate the machine tool in a manner dependent on the at least one person-related characteristic variable. What can advantageously be achieved by the method according to the invention is that the evaluation unit can communicate with different machine tools which are provided for an interchange of electronic data signals and/or control signals and/or person-related characteristic variables. In particular, the method according to the invention renders it possible for the operator to be able to work in a closed human-machine-safety system. What can advantageously be achieved thereby is that active protection with high safety for the operator can be provided when handling the hand-guided machine tool.

Here, the device according to the invention should not be restricted to the above-described application and embodiment. In particular, the device according to the invention can have a number of individual elements, components and units deviating from a number specified herein in order to fulfill a functionality described herein.

### DRAWING

Further advantages emerge from the following description of the drawing. An exemplary embodiment of the invention is depicted in the only drawing. The drawing, the description and the claims contain several features in combination. Expediently, a person skilled in the art will also consider the features individually and combine these into further expedient combinations.

The only FIGURE shows a device according to the invention with a clothing unit according to the invention, embodied as a jacket, as trousers, as a protective helmet, as a pair of shoes and as a pair of gloves, which comprises a sensor unit, an evaluation unit and a reception unit.

### DESCRIPTION OF THE EXEMPLARY EMBODIMENT

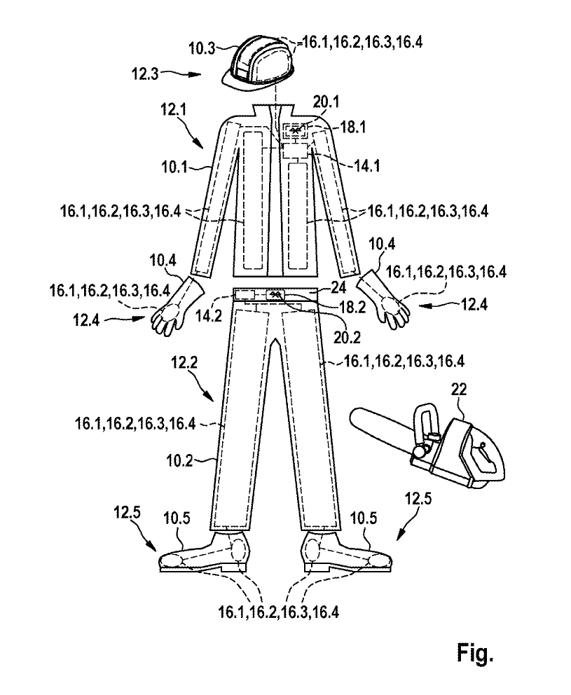

FIG. 1 shows a device for protecting an operator from being injured by a machine tool 22. The device comprises a sensor unit 12.1, 12.2, 12.3, 12.4, 12.5 arranged on a clothing unit 10.1, 10.2, 10.3, 10.4, 10.5 for detecting at least one characteristic variable and an evaluation unit 14.1, 14.2 for evaluating the at least one detected characteristic variable. The sensor unit 12.1, 12.2, 12.3, 12.4, 12.5 is expediently arranged on and in the clothing unit 10.1, 10.2, 10.3, 10.4, 10.5. The clothing unit 10.1, 10.2, 10.3, 10.4, 10.5 comprises at least one jacket. Furthermore, the clothing unit 10.1, 10.2, 10.3, 10.4, 10.5 comprises at least one pair of trousers. Moreover, the clothing unit 10.1, 10.2, 10.3, 10.4, 10.5 comprises at least one protective helmet. Moreover, the clothing unit 10.1, 10.2, 10.3, 10.4, 10.5 comprises a pair of shoes. The clothing unit 10.1, 10.2, 10.3, 10.4, 10.5 furthermore has a pair of gloves or alternatively/additionally other clothing unit parts appearing expedient to a person skilled in the art, such as e.g. an overall or an armband or a trouser belt 24. The evaluation unit 14.1, 14.2 is arranged in the jacket and/or in the trousers in each case, wherein the protective helmet, the shoes and the gloves do not have any evaluation units, but the sensor units 12.3, 12.4, 12.5 thereof are connected in a wireless manner to one of the two evaluation units 14.1, 14.2 in the jacket or in the trousers. Furthermore, the device comprises the sensor unit 12.1, 12.2, 12.3, 12.4, 12.5, which is embodied to detect person-related characteristic variables.

The sensor unit 12.1, 12.2, 12.3, 12.4, 12.5 comprises at least one acceleration sensor element 16.1 for detecting jerky movements of the operator. Overall, the sensor unit 12.1, 12.2, 12.3, 12.4, 12.5 has a multiplicity of acceleration sensor elements 16.1. The acceleration sensor elements 16.1 are applied in the clothing unit 10.1, 10.2, 10.3, 10.4, 10.5 in the outer region of the hands and/or the feet and/or the head, in particular in the gloves and/or in the shoes. The characteristic variables in the vicinity of the person occurring by means of the acceleration sensor elements 16.1 are greatest in the extremities. Therefore, jerky movements of the extremities already can be detected particularly quickly at the start of a movement. In the present exemplary embodiment, the acceleration sensor elements 16.1 are arranged in the outer sleeve regions of the jacket and/or the trousers. Here, the acceleration sensor elements 16.1 are connected to the evaluation unit 14.1, 14.2 in a wired manner. Alternatively, the acceleration sensor elements 16.1 can be arranged in the gloves, shoes or in the helmet and they are then connected in a wireless manner to the evaluation unit 14.1, 14.2. Four or five acceleration sensor elements 16.1, which are arranged in the outer region of the hands and the feet and the head, are used.

Furthermore, the sensor unit 12.1, 12.2, 12.3, 12.4, 12.5 comprises at least one position sensor element 16.2 and/or a GPS sensor element 16.3 for detecting a horizontal and/or vertical position and/or geographical location of the operator. The position sensor element 16.2 and/or the GPS sensor element 16.3 can be arranged both on the front side and on the rear side of the clothing unit 10.1, 10.2, 10.3, 10.4, 10.5. The position sensor element 16.2 and/or the GPS sensor element 16.3 are connected in a wired manner to the evaluation unit 14.1, 14.2. However, a wireless connection between the position sensor element 16.2 and/or the GPS sensor element 16.3 and the evaluation unit 14.1, 14.2 is also conceivable.

Furthermore, the sensor unit 12.1, 12.2, 12.3, 12.4, 12.5 comprises at least one vital sensor element 16.4 for detecting a vital function of the operator. Overall, the sensor unit 12.1, 12.2, 12.3, 12.4, 12.5 has a multiplicity of vital sensor elements 16.4. In order to monitor the vital function of the operator, the vital sensor elements 16.4 in the current exemplary embodiment are arranged as a blood pressure cuff in the upper and lower sleeve regions of the jacket for the purposes of detecting the blood pressure and/or the pulse. Additionally, one of the vital sensor elements 16.4 detects a body temperature of the operator. The vital sensor elements 16.4 are connected to the evaluation unit 14.1, 14.2 in a wired manner. However, a wireless connection between the vital sensor elements 16.4 and the evaluation unit 14.1, 14.2 is also conceivable.

In order to receive the person-related characteristic variables detected by the sensor unit 12.1, 12.2, 12.3, 12.4, 12.5 and evaluated by the evaluation unit 14.1, 14.2, the device according to the invention comprises a reception unit 18.1, 18.2. In the present exemplary embodiment, the reception unit 18.1 is arranged in a removable manner in an inner pocket of the jacket of the clothing unit 10.1, wherein the reception unit 18.2 can likewise be integrated into a trouser belt 24 of the clothing unit 10.2. Therefore, the reception unit 18.1, 18.2 forms an internal reception unit. The reception unit 18.1, 18.2 is detachably connected to the evaluation unit 14.1, 14.2 in a wired manner. However, a wireless connection between the reception unit 18.1, 18.2 and the evaluation unit 14.1, 14.2 is also conceivable.

The reception unit 18.1, 18.2 can be arranged within the clothing unit 10.1, 10.2, 10.3, 10.4, 10.5 or outside of the clothing unit 10.1, 10.2, 10.3, 10.4, 10.5. In this case, the reception unit 18.1, 18.2 can be embodied in an arrangeable removable manner on the clothing unit 10.1, 10.2, 10.3, 10.4, 10.5, for example as a small handheld instrument (a smartphone or mobile phone). However, it is also conceivable for the reception unit 18.1, 18.2 to be embodied as an external reception unit which is arranged outside of the clothing unit 10.1, 10.2, 10.3, 10.4, 10.5. The external reception unit can be embodied as a computer or as a notebook. In the present exemplary embodiment, the device comprises at least one internal reception unit 18.1, 18.2 and also at least one external reception unit. The internal reception unit 18.1, 18.2 is separable from the evaluation unit 14.1, 14.2 and connectable to the external reception unit in a wired or wireless manner.

In order to enable communication between the evaluation unit 14.1, 14.2 and the reception unit 18.1, 18.2, the reception unit 18.1, 18.2 has a communication unit 20.1, 20.2 which is provided to transfer the at least one detected person-related characteristic variable to the machine tool 22 and to deactivate the machine tool 22 in a manner dependent on the at least one person-related characteristic variable. To this end, the communication unit 20.1, 20.2 has wireless Bluetooth transmission technology. Alternatively or additionally, the communication unit 20.1, 20.2 additionally has WLAN transmission technology for transfer purposes or for communicating with the external reception unit.

The reception unit 18.1, 18.2 is embodied for monitoring persons and/or for transmitting and/or receiving an emergency signal. To this end, both the internal reception unit 18.1, 18.2 and the external reception unit are provided to transmit and/or receive an emergency signal, with said units carrying out the monitoring of persons separately from one another and being able to emit an emergency signal. On account of the double security, the device according to the invention enables an emission of an emergency call as a result thereof, even if one of the two reception units 18.1, 18.2 has a fault.

The reception unit 18.1, 18.2 is provided to document and/or analyze the received characteristic variables from the sensor unit 12.1, 12.2, 12.3, 12.4, 12.5. Both the internal and the external reception unit store all person-related characteristic variables during the machining process with the machine tool 22. The evaluation unit 14.1, 14.2 is provided to evaluate all person-related characteristic variables detected by means of the sensor units 12.1, 12.2, 12.3, 12.4, 12.5, which are provided to interrupt or deactivate the machine tool 22 during the machining process. The external reception unit (not depicted here) is embodied as a mobile computer with a WLAN interface, which communicates with the WLAN interface of the communication unit 20.1, 20.2.

In order to provide a method for protection from being injured by a machine tool 22, which method enables active protection of an operator, the sensor unit 12.1, 12.2, 12.3, 12.4, 12.5 detects the at least one person-related characteristic variable which is evaluable by the evaluation unit 14.1, 14.2. After evaluating the person-related characteristic variables, the evaluation unit 14.1, 14.2 transmits a signal to the internal reception unit 18.1, 18.2 or external reception unit, which is provided to deactivate the machine tool 22 in a manner dependent on the at least one predetermined person-related characteristic variable, if a threshold of the at least one characteristic variable of the sensor unit 12.1, 12.2, 12.3, 12.4, 12.5 stored in the evaluation unit 14.1, 14.2 is exceeded.

1. A device for protecting an operator from being injured by a machine tool, comprising:
at least one sensor unit arranged on a clothing unit and configured to detect at least one person-related characteristic variable; and
at least one evaluation unit configured to evaluate the at least one detected person-related characteristic variable.

2. The device as claimed in claim 1, wherein the at least one sensor unit comprises at least one acceleration sensor element configured to detect jerky movements of the operator.

3. The device as claimed in claim 1, wherein the at least one sensor unit comprises at least one position sensor element and/or a GPS sensor element configured to detect a horizontal and/or a vertical position and/or a geographical location of the operator.

4. The device as claimed in claim 1, wherein the at least one sensor unit comprises at least one vital sensor element configured to detect a vital function of the operator.

5. The device as claimed in claim 1, further comprising:
a reception unit configured to receive the at least one detected person-related characteristic variable from the evaluation unit.

6. The device as claimed in claim 5, wherein the reception unit is arranged within the clothing unit or outside of the clothing unit.

7. The device as claimed in claim 5, wherein:
the reception unit has a communication unit for transferring configured to transfer the at least one detected person-related characteristic variable to the machine tool, and
the machine tool is deactivatable in a manner dependent on the at least one predetermined person-related characteristic variable.

8. The device as claimed in claim 5, wherein the reception unit is configured to monitor a person and/or to transmit and/or to receive an emergency signal.

9. The device as claimed in claim 5, wherein the reception unit is configured to document and/or analyze the at least one received person-related characteristic variable from the at least one sensor unit.

10. A method for protecting an operator from being injured by a machine tool by way of a device comprising at least one sensor unit arranged on a clothing unit and configured to detect at least one characteristic variable and which comprises at least one evaluation unit configured to evaluate the at least one detected characteristic variable, comprising:
detecting person-related characteristic variables with the at least one sensor unit;
transferring the detected person-related characteristic variable by way of the at least one evaluation unit to a reception unit; and
deactivating the machine tool in a manner dependent on the transferred at least one person-related characteristic variable.
